(19) United States
(12) Patent Application Publication
(10) Pub. No.: US 2005/0093457 A1
(43) Pub. Date: May 5, 2005

(54) Self test emergency ballast

(76) Inventor: Glenn A. Hamblin, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/700,307

(22) Filed: Oct. 31, 2003

(51) Int. Cl. H05B 37/00; H05B 37/02

(52) U.S. Cl. 315/86; 315/308

(57) ABSTRACT

An emergency lighting battery system for handling failure of primary power sources. A processing device contains a state-machine, which includes the steps of initialization, start-up, charge, test, and emergency response. Variables, parameters, and, flags are stored in volatile and non-volatile memory. A watch-dog timer is utilized to recover from processor lock-up. A single voltage input wire is utilized for both 120VAC and 277VAC power sources. A time-delay is utilized for compatibility with most ballasts. Recent test and status information is transmitted through an audible speaker or light-emitting device.

### BACKGROUND OF THE INVENTION

1. Field of the Invention

This invention is related in general to the field of emergency lighting systems. In particular, the invention responds to primary power source failures by inverting electrical current flow from a battery utilizing a ballast including a processing device, volatile and non-volatile memory, inverters, relays, and a time delay function.

2. Description of the Prior Art

It is common to use battery systems to maintain power to lighting systems when a primary power source has failed. Early battery systems were made with simple electrical relays that remained closed while the primary power source was active, allowing the primary power source to both power the lighting system and charge a battery. Upon failure of the primary power source, the relays would up and the battery would provide power for the lighting system.

Over the years, emergency lighting systems have become increasingly sophisticated. It is now common to utilize processing devices to monitor the state of the primary power source, monitor the state of the battery, control the flow of electricity, perform tests on the battery, and report the status of the emergency lighting system in general and the battery in particular.

However, it is desirable to have an emergency lighting system that can be connected to more than one type of power source. While most emergency lighting systems are connected to 120-volt alternating current power sources, it would be advantageous to have the option of connecting them to other power sources, such as 277-volt alternating current. In the past, optionally connecting an emergency lighting system to multiple potential power sources required multiple source input wires, one for each type of power source. It is desirable to have an emergency lighting system that utilizes a single input wire to connect with more than one type of power source. In order to accommodate multiple power sources, it is also advantageous to have a current sensing circuit and a time-delay function to prevent damage to the lighting system.

Another difficulty of utilizing sophisticated emergency lighting systems is that processing devices have a tendency to freeze or lock-up. Often, this problem goes un-noticed for extended periods of time. To this end, it is desirable to have a watch-dog timer for monitoring the operation of the processor and re-initialization. It is also desirable to have a non-volatile memory for storing variable, parameters, flags, and machine states. This provides information to a re-initialized processing device not available from volatile memory.

Most emergency lighting systems provide a means for testing the performance of the system and checking the condition of the battery. Some of these testing methods are automated. However, it may be inconvenient if these tests occurred while the area being illuminated by the emergency lighting system is occupied. To this end, it would be desirable to have a means for detecting if the area is occupied and deferring any automated tests until the area become unoccupied. It is also desirable to have a means for initiating a test of the system on demand.

Once a test has been performed, it is important that the results of the test be available to interested persons. If a failure occurs during a test, it is desirable to transmit a high priority message that can be observed by persons in the area of the emergency lighting system. Additionally, it is desirable to have recent test information and emergency lighting system status information discernable by casual observation of the emergency lighting system.

### SUMMARY OF THE INVENTION

This invention is based on utilizing a processing device, an occupation sensor, a multi-source power source, a battery, information transmission devices, inverters, relays, and a time-delay function to create an efficient and effective Emergency Lighting Battery System (“System”). The System is designed to ensure that the battery is always ready in the case of the need for emergency lighting. This is accomplished by continuously monitoring the charge circuit and battery voltage and performing periodic functional testing at intervals and durations that meet or exceed regulatory standards for emergency battery packs.

The System also contains additional features that make installation and use more convenient. Among these features are a single wire to connect the un-switched power source to either 120VAC or 277VAC, Occupation Awareness Sensing that prevents testing during times when the room or office is occupied, a time-delayed enabling of the ballast to help ensure that the unit is compatible with almost any type and manufacturer of alternating current ballast, and a watch-dog timer that will reset the processing device should it lock-up or freeze due to code execution errors or electrical line irregularities.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram illustrating the major components of the Emergency Lighting Battery System, according to the invention.

FIG. 2 is a block diagram illustrating the Multi-Voltage Power Circuit.

FIG. 3 is a block diagram illustrating the Processing Circuit.

FIG. 4 is a block diagram illustrating the contents of Non-Volatile Memory.

FIG. 5 is a block diagram illustrating the Processing Device.

FIG. 6 is a flow chart illustrating the State Machine, according to the invention.

### DESCRIPTION OF THE PREFERRED EMBODIMENTS

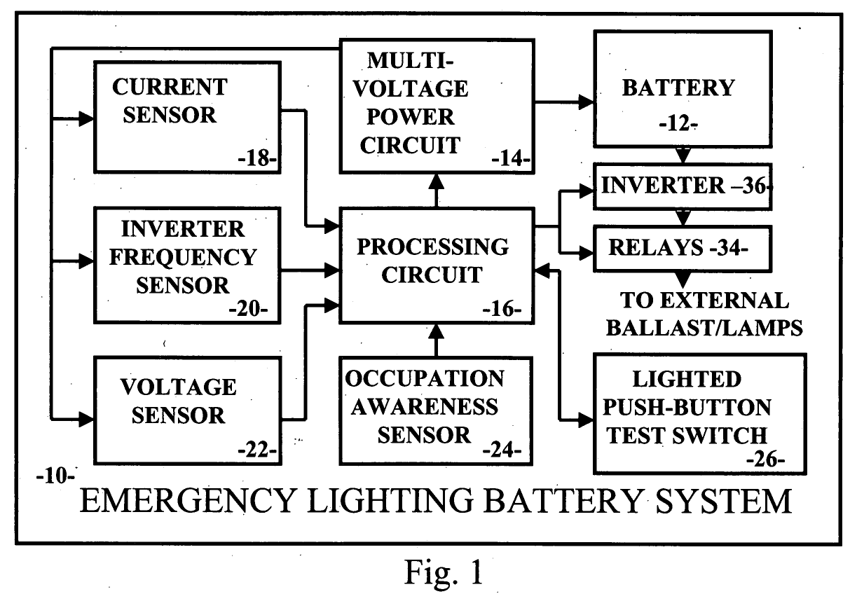

As a general overview of the invention, the block diagram of FIG. 1 shows an Emergency Lighting Battery System 10. A Battery 12 is charged by a Multi-Voltage Power Circuit 14 and is used to power illumination devices, such as fluorescent light bulbs. The illumination process is implemented and controlled by the Inverter 36 and the Relays 34. A Processing Circuit 16 controls the Multi-Voltage Power Circuit 14, the Inverter 36, and the Relays 34 and receives input from the Current Sensor 18, the Inverter Frequency Sensor 20, the Voltage Sensor 22, and the Occupation Awareness Sensor 24. A Lighted Push-Button Test Switch 26 (“Button”) is used to input a test request from a user and to visually transmit information to observers.

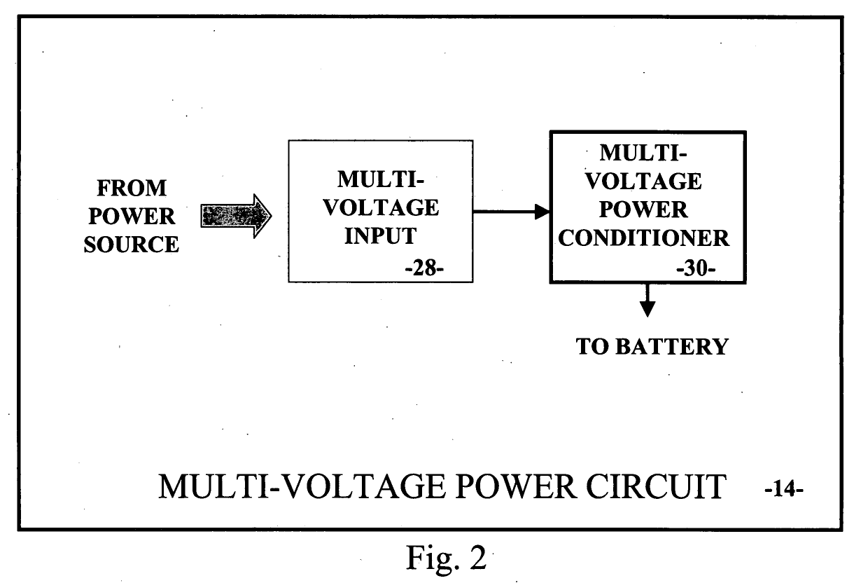

The block diagram of FIG. 2 illustrates the major components of the Multi-Voltage Power Circuit 14. The Multi-Voltage Input 28 is a single input channel that may be connected to various power sources, such as 120-volt alternating current or 277 volt alternating current. Alternate embodiments of the invention may contain a Multi-Voltage Input 28 that is a universal input circuit allowing for input voltages of 85-300 volts AC at 50-60 Hz. The Multi-Voltage Power Conditioner 30 determines the voltage level of the input power source and conditions the power to produce a pre-determined voltage output. The output may be, but is not limited to, a direct current value.

Electrical current flow is normally from the input power source to the Battery 12. However, if the input power source becomes inoperative or unstable, Relays 34 and Inverters 36 are used draw power from the Battery 12. Newer electronic ballasts contain algorithms and circuitry to detect Lamp End of Life conditions or defective lamps. Switching the Relays 34 on or off can create relay bounce, preventing the external ballast from attempting to light its associated lamps. To prevent this condition, a time delay function deactivates the external ballast for a short period of time to allow the contacts to settle. The time delay function is implemented utilizing the Processing Circuit 16 controlling the Inverter 36.

Another issue arises if the external ballast is powering its associated lamps and the Relays 34 are opened, creating an arc that will damage or shorten the life of the relay. To prevent this, the time delay function is implemented to first disconnect the power source to the external ballast, allowing the circuit to discharge, and then opening the Relays 34.

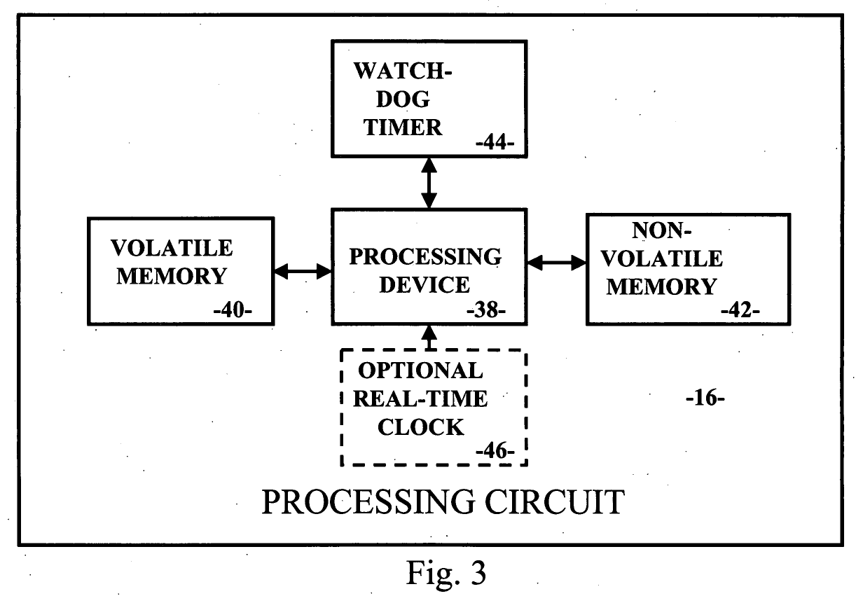

The Processing Circuit 16 is illustrated by the block diagram of FIG. 3. A Processing Device 38 may be any electrical device capable of processing operating instructions such as a microprocessor, Field Programmable Gate Array (“FPGA”), or Complex Programmable Logic Device (“CPLD”). Traditionally, Processing Devices 38 require external Volatile Memory 40 for the temporary storage of operating instructions, parameters, and variables. However, the Processing Device 38 may optionally include internal Volatile Memory.

Non-Volatile Memory 42 is used to hold configuration information for the Processing Device 38. Additionally, the Non-Volatile Memory may be used to store the contents of the Processing Device's registers. This information is referred to as the Processing Device's machine state. As with the Volatile Memory 40, Non-Volatile Memory is traditionally located external to the Processing Device 38. However, the Processing Device may optionally contain its own internal Non-Volatile Memory.

A Watch-Dog Timer 44 is used to monitor the Processing Device 38. If the Processing Device is inactive for an extended period of time, the Watch-Dog Timer will re-initialize the device. An Optional Real-Time Clock 46 may be included in the Processing Circuit 16.

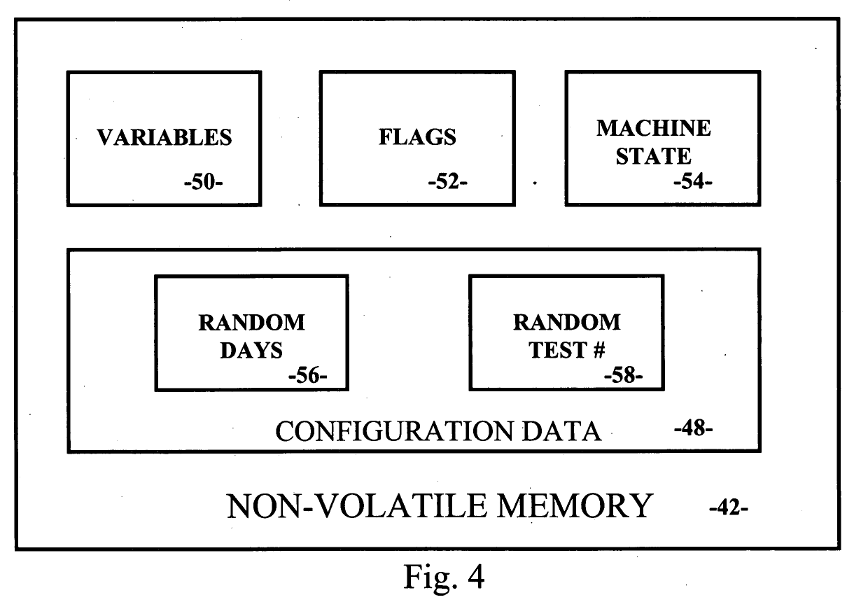

Configuration Data 48, Variables 50, Parameters 52, and the Machine State 54 are stored in the Non-Volatile Memory 42, as shown in FIG. 4. The Configuration Data 48 includes a register for holding a Random Days Value 56 and another one for a Random Test Number 58.

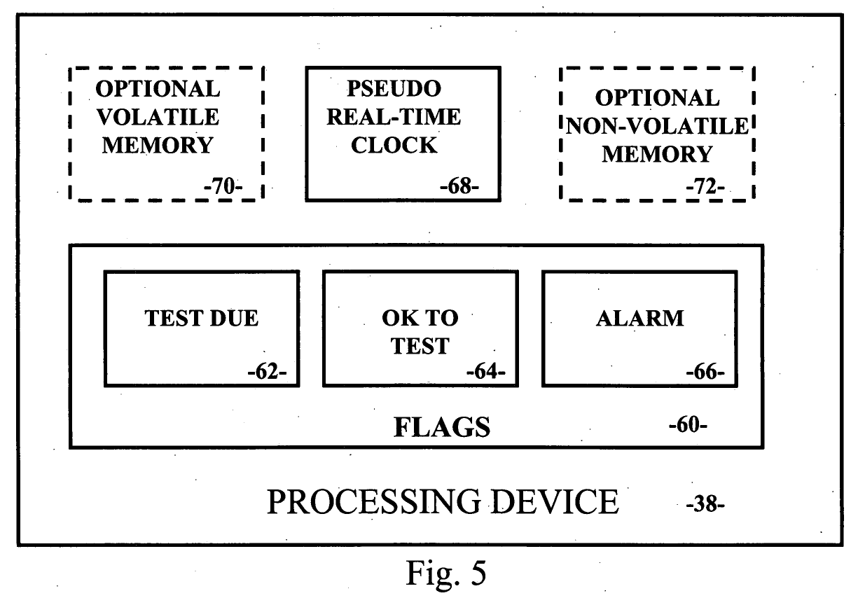

Some of the components of the Processing Device 38 are shown in FIG. 5.

Registers are used to store Flags 60. Some of the Flags 60 are Test Due Flag 62, OK To Test Flag 64, and Alarm Flag 66. If the Optional Real-Time Clock 46 (FIG. 3) is not utilized, a Pseudo Real-Time Clock 68 (“Clock”) may be provided. Internal Optional Volatile Memory 70 and internal Optional Non-Volatile Memory 72 may be utilized.

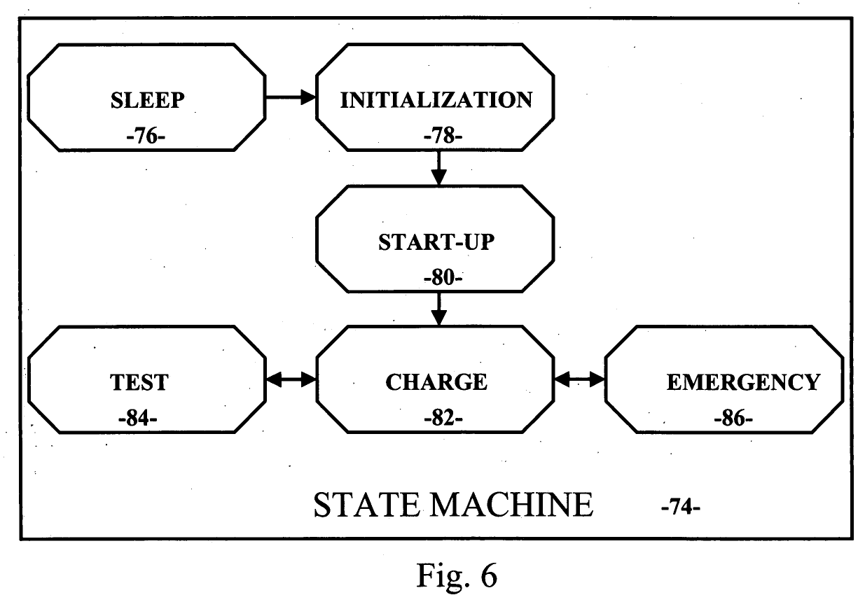

In the preferred embodiment of the invention, a State Machine 74, as illustrated in FIG. 6, is processed by the Processing Device 38. The State Machine has six prominent stages: Sleep 76, Initialization 78, Start-Up 80, Charge 82, Test 84, and Emergency 86.

When the input power source is inactive or unstable, the State Machine 74 is in Sleep 76 state and the Processing Device 38 draws a negligible amount of current from the Battery 12. Once a stable connection is made to the input power source, the Processing Device 38 enters Initialization 78. Configuration Data, including the Random Days Variable 56 and the Random Test Number 58, is read from Non-Volatile Memory 42 or Optional Non-Volatile Memory 72.

In the preferred embodiment of the invention, the Random Days Variable 56 is initially preset between and including the numbers of 1 and 28. While the Processing Device is active, the Random Days Variable 56 is incremented once every 24 hours. The Random Test Number 58 is also preset between and including the numbers of 1 and 12. The Random Test Number 58 is thereafter incremented after every battery test.

Once the Configuration Data 48 has been loaded into the Processing Device 38, the Pseudo Real-Time Clock 68 is initialized. The purpose of the Pseudo Real-Time Clock is to keep track of seconds, minutes, hours, days, and months. Once Initialization 78 is complete, the State Machine 74 enters the Start-Up 80 state.

In Start-Up 80, current flowing to the Battery 12 is monitored by the Current Sensor 18. Additionally, the Voltage Sensor 22 determines the level of the input voltage of the input power source. The Multi-Voltage Power Conditioner 30 adjusts the power accordingly. Other conditions for entering Start-Up 80 include failure of the Battery 12 during a test or emergency, a test completion, or a restart performed by the Watch-Dog Timer 44.

Once a stable current is provided by the input power source, the State Machine 74 enters the Charge 82 state. During normal operation, the Emergency Lighting Battery 15. System 10 will spend of the majority of the time in this state. In this state, a positive visual indicator is transmitted to the Lighted Push-Button Test Switch 26 to indicate that the System 10 is operating properly. In the preferred embodiment of the invention, this positive visual indicator is green. In an alternate embodiment of the invention, other colors may be used, or the absence of any light may be an indication of normal operation. In yet another embodiment, the positive visual indicator may be replaced with an audible tone emitting from a speaker.

During normal operation within the Charge 82 state, current flowing to the Battery 12 and the battery voltage are constantly monitored. The Pseudo Real-Time Clock 68 continues to update the seconds, minutes, hours, days, and months. If the “days” value is equal to or greater than 26, the Processing Device 38 will set the Test Due Flag 62. Once the Test Due Flag has been set, the Emergency Lighting Battery System will attempt to perform a self-test within the next 2 days.

Once the Test Due Flag 62 has been set, the Occupation Awareness Sensor 24 is monitored. If the Occupation Awareness Sensor indicates that no persons are present in the illumination area controlled by the System 10, the OK To Test Flag 64 is set. Once both the Test Due and OK To Test flags have been set, the Random Test Number 58 (FIG. 4) is evaluated.

Additionally, the Processing Device 38 continuously monitors the Lighted Push-Button Test Switch 26 to ascertain whether the Button has been pushed. If the Button 26 has been pushed or the Clock 68 has initiated a self-test, the State Machine 74 will enter the Test 84 state (FIG. 6). In the preferred embodiment of the invention, a Random Test Number of 1 to 11 will generate a test lasting 30 seconds while a Random Test Number of 12 will result in a 90 minute test. The Random Test Number is then incremented. If the Random Test Number is greater than 12, it is reset to 1.

While in the Test 84 state, the Processing Device 38 disengages the Relays 34 (FIG. 2) and enables the Inverter 36. The Processing Device 38 controls and monitors the testing of the Battery 12. A test will end successful once the test time expires. Upon exiting the Test 84 state, the Processing Device will disable the Inverter 36 and engage the Relays 34.

The frequency of the Inverter 36 (FIG. 2) is monitored by the Inverter Frequency Sensor 20 (FIG. 1). The Inverter Frequency Sensor is a current limiting resistor in series with the collector of a transistor configured as an inverting switch. The inverting switch is connected to the input pin of a micro-controller containing protection diodes to clip the input voltage to the 0-5 volt range. A small capacitor connected to the input pin and the circuit ground removes any high frequency switching glitches. The input pin is connected to a counting circuit within the micro-controller. The test will terminate as unsuccessful if the inverter frequency or battery voltage is outside a prescribed range. A fail code is then generated and the Alarm Flag 66 (FIG. 5) is set. In the preferred embodiment of the invention, a test failure results in an error code being transmitted to the Lighted Push-Button Test Switch 26 every 15 seconds. Additionally, a retest will be performed within 2 days of the test failure.

While the State Machine 74 is within the Charge 82 state, the Processing Device 38 will transmit data to the Lighted Push-Button Test Switch 26 on a regular basis. In the preferred embodiment of the invention, this data is transmitted once per minute. While receiving a transmission from the Processing Device 38, the Lighted Push-Button Switch will flash.

The invention also transmits the data periodically via the Lighted Pus-Button Test Switch 26. The data is transmitted serially at a baud rate beyond human perception that visually appears as a “heart beat”, indicating the unit is operating properly. The transmitted data may include the Battery Voltage, the Charge Current, the Inverter Frequency, the Days Until the Next Test, Test Number, and Status Flags. In one embodiment of the invention, the visual signal is converted using a light level to RS-232 voltage level converter that may be read by any RS-232 capable device such as a Personal Digital Assistant (PDA) or Computer.

Other embodiments of the invention may utilize a centralized emergency ballast monitoring system placed in a location containing multiple Self Test Emergency Ballasts. An external data transmission system such as a radio transmitter or powerline data interface may be placed on each Self Test Emergency Ballast. The status of each Self Test Emergency Ballast is transmitted to the centralized emergency ballast monitoring system, allowing the status of all the Emergency Ballasts to be ascertained without physically touring the facility to check the status of each unit.

A loss of input power will cause the State Machine 74 to enter the Emergency 86 state (FIG. 4). A loss of power occurs when the input current falls below a preset threshold. Once the Emergency 86 state has been entered, the loss of coil current will cause the Relays 34 (FIG. 2) to switch. The Processing Device 38 then actuates the Inverter 36 (FIG. 2), allowing electrical current to flow from the Battery 12 to the illumination devices. The input current from the input power source is continually monitored to determine if it continuously exceeds a preset threshold. If the input current is stable for a preset period of time, the Processing Device 38 will disable the Inverter 36 and engage the Relays 34. The State Machine 74 will then return to the Charge 82 state.

Once each day, the Processing Device 38 stores the Variables 50, Flags 52, Machine State 54, and Clock 68 data to the Non-Volatile Memory 42 (FIG. 4). This data is also saved prior to entering the Emergency 86 state or the Test 84 state. This allows the Processing Device 38 to recover from a complete power-down state.

Others skilled in the art of making Emergency Lighting Battery Systems may develop other embodiments of the present invention. The embodiments described herein are but a few of the modes of the invention. Therefore, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

1. An Emergency Lighting Battery System, comprising:
a Battery;
a Processing Circuit;
a Multi-Voltage Power Circuit; and
an Occupation Awareness Sensor.

2. The Emergency Lighting Battery System of claim 1, further comprising:
a Current Sensor; and
a Voltage Sensor.

3. The Emergency Lighting Battery System of claim 2, further comprising:
a Lighted Push-Button Test Switch.

4. The Emergency Lighting Battery System of claim 3, further comprising an Inverter Frequency Sensor.

5. The Emergency Lighting Battery System of claim 3, wherein said Processing Circuit comprises:
a Processing Device, and
a Watch-Dog Timer.

6. The Emergency Lighting Battery System of claim 5, wherein said Processing Circuit further comprises:
a Volatile Memory; and
a Non-Volatile Memory.

7. The Emergency Lighting Battery System of claim 6, wherein said Processing Circuit further comprises an Optional Real-Time Clock.

8. The Emergency Lighting Battery System of claim 6, wherein said Processing Device comprises:
at least one Flag Register; and
a Pseudo Real-Time Clock.

9. The Emergency Lighting Battery System of claim 5, wherein said Processing Device comprises:
at least one Flag Register;
a Pseudo Real-Time Clock;
an Optional Volatile Memory; and
an Optional Non-Volatile Memory.

10. The Emergency Lighting Battery System of claim 6, wherein said Non-Volatile Memory stores Processor Configuration Data.

11. The Emergency Lighting Battery System of claim 10, wherein said Processor Configuration Data comprises:
a Random Days Variable; and
a Random Test Number.

12. The Emergency Lighting Battery System of claim 10, wherein said Non-Volatile Memory stores Variables, Flags, and Machine State.

13. The Emergency Lighting Battery System of claim 9, wherein said Optional Non-Volatile Memory stores Processor Configuration Data.

14. The Emergency Lighting Battery System of claim 13, wherein said Processor Configuration Data comprises:
a Random Days Variable; and
a Random Test Number.

15. The Emergency Lighting Battery System of claim 13, wherein said Optional Non-Volatile Memory stores Variables, Flags, and Machine State.

16. The Emergency Lighting Battery System of claim 5, wherein said Processing Device runs a State Machine.

17. The Emergency Lighting Battery System of claim 16, wherein said State Machine comprises:
a Sleep State;
an Initialization State;
a Start-Up State;
a Charge State;
a Test State; and
an Emergency State.

18. The Emergency Lighting Battery System of claim 16, wherein said Variables, Flags, and Machine State are written to said Non-Volatile Memory on a periodic basis.

19. The Emergency Lighting Battery System of claim 18, wherein said Processing Device runs a State Machine.

20. The Emergency Lighting Battery System of claim 19, wherein said Variables, Flags, and Machine State are written to said Non-Volatile Memory prior to said State Machine entering a Test State.

21. The Emergency Lighting Battery System of claim 19, wherein said Variables, Flags, and Machine State are written to said Non-Volatile Memory prior to said State Machine entering an Emergency State.

22. The Emergency Lighting Battery System of claim 5, wherein said Processing Device performs a self-test on a periodic basis.

23. The Emergency Lighting Battery System of claim 22, wherein Data is transmitted from said Processing Device to said Lighted Push-Button Switch.

24. The Emergency Lighting Battery System of claim 23, wherein said transmitted Data includes status information.

25. The Emergency Lighting Battery System of claim 24, wherein said status information is transmitted on a periodic basis.

26. The Emergency Lighting Battery System of claim 25, wherein said periodic status information includes error information.

27. The Emergency Lighting Battery System of claim 25, wherein said periodic status information is transmitted at a rate beyond human perception.

28. The Emergency Lighting Battery System of claim 27, wherein said transmitted periodic status information appears to human observers as a periodic heart beat.

29. The Emergency Lighting Battery System of claim 2, further comprising:
a Switch; and
an External Data Transmission System.

30. The Emergency Lighting Battery System of claim 29, wherein said External Data Transmission System comprises a radio transmitter.

31. The Emergency Lighting Battery System of claim 29, wherein said External Data Transmission System comprises a powerline data interface.

32. The Emergency Lighting Battery System of claim 29, wherein said External Data Transmission System transmits data to a Central Data Collection point.
